(19) United States
(12) Patent Application Publication
(10) Pub. No.: US 2013/0164719 A1
(43) Pub. Date: Jun. 27, 2013

(54) DIGITAL MATH TUTORIAL FOR STUDENTS

(71) Applicant: Daniel Judge Villamar, North Las Vegas, NV (US)

(72) Inventor: Daniel Judge Villamar, North Las Vegas, NV (US)

(21) Appl. No.: 13/436,951

(22) Filed: Apr. 1, 2012

Related U.S. Application Data
(60) Provisional application No. 61/631,092, filed on Dec. 27, 2011.

(51) Int. Cl. G09B 5/00

(52) U.S. Cl. 434/201

(57) ABSTRACT

Computer-implemented methods and systems for teaching students how to solve mathematical problems are provided. An example method may comprise providing a question description to one or more student terminals, with the question description representing a mathematical problem. The method may further comprise aggregating subsequent statements from the one or more student terminals, wherein the subsequent statements represent steps in the solution of the mathematical problem, and matching the statements against a database of mathematical rules associated with the mathematical problem. The method may further comprise storing information on the step and the particular student who provided the incorrect statement in a control database if a statement provided by a particular student does not match a corresponding mathematical rule associated with the mathematical problem. The method may further comprise providing aggregated information of the control database for displaying on a teacher terminal.

### CROSS-REFERENCE TO RELATED APPLICATIONS

This application claims priority of U.S. Provisional Application No. 61/631,092, entitled “Digital Math Tutorial for Students,” filed on Dec. 27, 2011, which is incorporated herein by reference in its entirety for all purposes.

### BACKGROUND

1. Technical Field

This disclosure relates generally to student teaching systems and, more particularly, to computer-implemented methods and systems for student teaching of mathematics and related subjects.

2. Description of Related Art

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Educational software has been constantly growing over the past decades, and now it is widely used in schools, colleges, universities, and homes. Some educational software applications become especially important and popular as they facilitate not only the studying process, but also permit providing computer-based tests for students.

Currently, there are several types of educational software (which may be differentiated, for example, by a teaching subject), but, in general, students are faced with questions and prompted to input answers to the questions. The answers can be checked, aggregated, and a final score or mark calculated afterwards for the students or teachers.

While such educational software enables effective testing of students' knowledge, this software does not actually help students learn how to solve certain problems. It is especially important when students learn mathematics or related subjects such as geometry, algebra, calculus, logic, combinatorics, and so forth. One of the major drawbacks of conventional educational software is that for complex mathematical problems, which require performing several steps to find an answer, the conventional educational software typically can process input of final answers only. Without asking a teacher, the students are not typically able to learn how various complex mathematical problems can be solved. In other words, the conventional educational software is not able to check how the students solve a given mathematical problem on a “step-by-step” basis, and instead is only able to inform if the provided final answer is correct.

Another problem with the conventional educational software is that it does not allow for teachers to see how students solve the aforementioned complex mathematical problems. If a student gives a wrong answer, there is no information for the teachers as to what specifically a particular student did wrong when he or she tried to solve the given problem.

In this respect, there is still a need to develop educational software and educational systems to enhance the educational process for both students and teachers.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with an aspect, a computer-implemented method for teaching mathematics is provided. An example method may comprise providing a question description to one or more student terminals, with the question description representing a mathematical problem. The method may further comprise aggregating subsequent statements from the one or more student terminals, wherein the subsequent statements represent steps in the solution of the mathematical problem, and matching the statements against a database of mathematical rules associated with the mathematical problem. The method may further comprise storing information related to the step and the particular student provided the incorrect statement in a control database if a statement provided by the particular student does not match a corresponding mathematical rule associated with the mathematical problem. The method may further comprise providing aggregated information of the control database for displaying on a teacher terminal.

According to some embodiments, the method may further comprise sending an error signal to the particular student terminal if a statement provided by a particular student does not match a corresponding mathematical rule associated with the mathematical problem, and sending a confirmation signal to the particular student terminal if a statement provided by a particular student matches a corresponding mathematical rule associated with the mathematical problem. A statement comprises one or more of a mathematical operator, a number, and a character. The method may further comprise receiving a hint request associated with a particular step in the solution of the mathematical problem and storing information on the step and the particular student who sent the hint request in the control database.

The method may further comprise providing supportive information to the particular student terminal in response to the hint request. The supportive information can comprise one or more of an answer to the mathematical problem and a suggestion on an action to be performed by the particular student. The method may further comprise storing the incorrect statement in the control database if a statement provided by a particular student does not match a corresponding mathematical rule associated with the mathematical problem. The method may further comprise enabling or disabling highlighting of one or more parts related to the mathematical problem on at least one student terminal in response to a control command given via the teacher terminal. The mathematical problem may comprise a multiple-step mathematical problem. The method may further comprise storing information on the step, and the particular student who provided the correct statement, in the control database if a statement provided by a particular student matches a corresponding mathematical rule associated with the mathematical problem. The method may further comprise sorting the aggregated information in the control database before displaying on the teacher terminal. The sorting is performed against student names, correct statements, and incorrect statements.

According to another aspect, a system for teaching mathematics is provided. The system may comprise a communication module configured to provide a question description to one or more student terminals, with the question description representing a mathematical problem and aggregate subsequent statements from the one or more student terminals, wherein the subsequent statements represent steps in the solution of the mathematical problem. The system may further comprise a computing module configured to match the statements against a database of mathematical rules associated with the mathematical problem, and if a statement provided by a particular student does not match a corresponding mathematical rule associated with the mathematical problem, store information on the step and the particular student who provided the incorrect statement in a control database. The communication module can be further configured to provide aggregated information of the control database for displaying on a teacher terminal.

The computing module can be further configured to send an error signal to the particular student terminal if a statement provided by a particular student does not match a corresponding mathematical rule associated with the mathematical problem and send a confirmation signal to the particular student terminal if a statement provided by a particular student matches a corresponding mathematical rule associated with the mathematical problem. The communication module can be further configured to receive a hint request associated with a particular step in the solution of the mathematical problem. The computing module can be further configured to store information on the step and the particular student who sent the hint request in the control database. The computing module can be further configured to provide supportive information to the particular student terminal in response to the hint request. The computing module can be further configured to store the incorrect statement in the control database if a statement provided by a particular student does not match a corresponding mathematical rule associated with the mathematical problem. The computing module can be further configured to enable or disable highlighting of one or more parts related to the mathematical problem on at least one student terminal in response to a control command given via the teacher terminal. The computing module can be further configured to store information on the step and the particular student who provided the correct statement in the control database if a statement provided by a particular student matches a corresponding mathematical rule associated with the mathematical problem.

According to yet another aspect, there is provided a networked system for teaching mathematics. The networked system comprises a communication network, at least one teacher terminal, and one or more student terminals. Each student terminal is operably connected to the at least one teacher terminal via the communication network. The at least one teacher terminal comprises a computer-readable medium having instructions stored thereon, which when executed by the at least one teacher terminal cause the at least one teacher terminal to provide a question description to one or more student terminals, wherein the question description represents a mathematical problem; aggregate subsequent statements from the one or more student terminals, wherein the subsequent statements represent steps in the solution of the mathematical problem; match the statements against a database of mathematical rules associated with the mathematical problem; store information on the step and the particular student who provided the incorrect statement in a control database if a statement provided by a particular student does not match a corresponding mathematical rule associated with the mathematical problem; and provide aggregated information from the control database for displaying on a teacher terminal.

According to yet another aspect, there is provided a computer-readable medium having instructions stored thereon, which when executed by one or more computers, cause the one or more computers to provide a question description to one or more student terminals, wherein the question description represents a mathematical problem; aggregate subsequent statements from the one or more student terminals, wherein the subsequent statements represent steps in the solution of the mathematical problem; match the statements against a database of mathematical rules associated with the mathematical problem; store information on the step and the particular student who provided the incorrect statement in a control database if a statement provided by a particular student does not match a corresponding mathematical rule associated with the mathematical problem; and provide aggregated information from the control database for displaying on a teacher terminal.

To the accomplishment of the foregoing and related ends, the one or more aspects comprise the features hereinafter fully described and particularly pointed out in the claims. The following description and the drawings set forth in detail show certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 shows a block diagram illustrating a networked system environment suitable for implementing methods of teaching students to solve mathematical problems, according to an example embodiment.

FIG. 2 shows a block diagram illustrating a networked system environment suitable for implementing methods of teaching students to solve mathematical problems, according to another example embodiment.

FIG. 3 is a block diagram of a system for teaching mathematics, according to an example embodiment.

FIG. 4 is a process flow diagram showing a method for teaching mathematics, according to an example embodiment.

FIGS. 5A-5G are simplified illustrations of a graphical user interface displayable on a student terminal, according to an example embodiment.

FIGS. 6A and 6B are simplified illustrations of a graphical user interface displayable on a teacher terminal, according to an example embodiment.

FIG. 7 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium such as a carrier wave, disk drive, or computer-readable medium. Exemplary forms of carrier waves may take the form of electrical, electromagnetic, or optical signals conveying digital data streams along a local network or a publicly accessible network such as the Internet.

The embodiments described herein relate to computer-implemented methods and systems for teaching students how to solve various mathematical problems. As used herein, the term “mathematical problem” may refer to any educational question which can be solved on a “step-by-step” basis. The educational question may refer to any mathematics topic including, but not limited to, algebra, calculus, geometry, topology, combinatorics, logic, number theory, differential equations, mathematical physics, computing, information theory and signal processing, and probability statistics.

There can be provided a networked system of at least one teacher terminal and at least one student terminal coupled together via a network like the Internet or local area network (LAN). The teacher terminal or a dedicated server may host a software application enabling performance of various methods for teaching students, as described herein. More specifically, students are provided with questions related to mathematical problems by sending corresponding instructions to display the questions and prompting to input an answer to the student terminals. On every step of solving the given mathematical problem, the students may generate an input statement which is then sent to the teacher terminal. To generate an input statement, the students are prompted to click a button (e.g., to select a certain mathematical operation) and/or input a certain number or character. The given statements, once sent to the teacher terminal, are checked by mapping to a set of rules associated with the provided mathematical problem, and the result of checking (e.g., “provided statement on step k is correct” or “provided statement on step l is incorrect”) is then stored in a control database.

Accordingly, the control database aggregates information on how students are solving particular mathematical problems step-by-step. This information is aggregated and available for a teacher's review on every step made by all students in the process of solving complex mathematical problems. Thus, if a student made a mistake on a certain step, the teacher may readily understand at what specific step the student made this mistake. All errors made during the educational process may be aggregated and presented on a display of the teacher terminal so the teacher may review the entire group of students and their progress in solving a given task at a glance. In particular, the teacher may be provided with information as to what mistakes were made and by what students, statistical or sorted information, or detailed information on any particular student selected by the teacher.

Further, the students may be provided with an option to request a hint or suggestion on a specific step of solving the given mathematical problem. For this purpose, the students may press a dedicated button on the display of their computers, and the teacher terminal, in response, provides a suggestion text, images, audio, or video. The teacher terminal may also highlight certain parts of the given mathematical problem or associated parts in order to give a corresponding clue for the students.

Those skilled in the art would appreciate that various embodiments related to computer-implemented methods for teaching mathematics are advantageous and overcome the drawbacks of the prior art systems. The methods described herein enable teachers to readily understand at what steps students made mistakes in solving mathematical problems. In particular, this may enhance principles of teaching as the teachers may adapt their course to a particular class or a particular student. Moreover, from the students' perspective, the education process may go faster and easier, since the described technology enables evaluation of every step taken in solving given mathematical problems.

The following provides the detailed description of various embodiments related to methods and systems for teaching mathematics.

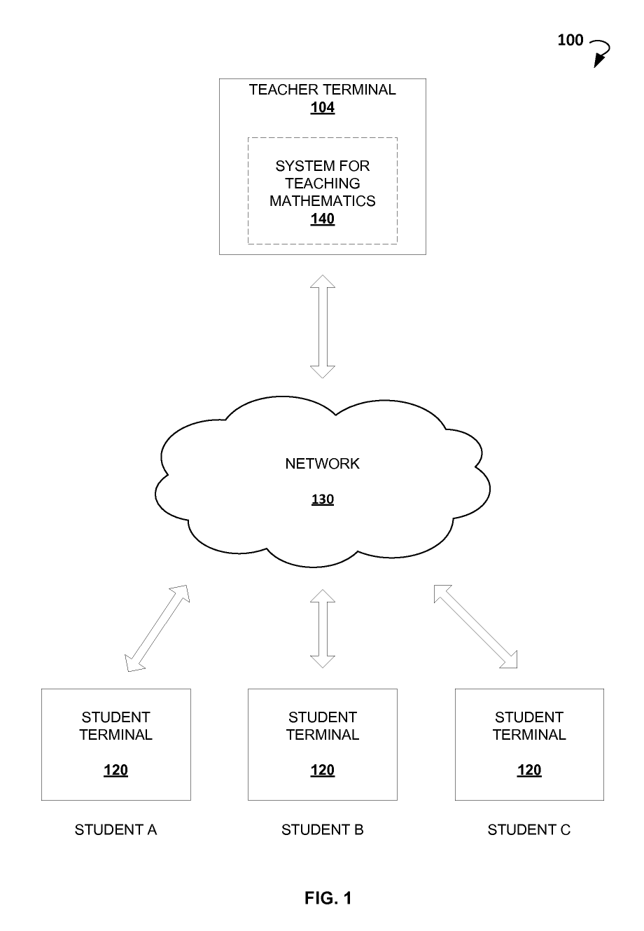

Referring now to the drawings, FIG. 1 shows a block diagram illustrating a system environment 100 suitable for implementing methods of teaching students to solve mathematical problems, according to an example embodiment. The system environment 100 comprises one or more teacher terminals 104, one or more student terminals 120, and a network 130. The network 130 may couple the aforementioned modules.

The network 130 is a network of data processing nodes interconnected for the purpose of data communication, which may be utilized to communicatively couple various components of the environment 100. The network 130 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 130 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

As used herein, the term “teacher terminal” or “student terminal” refers to a computer, a workstation, a server, a laptop, a tablet computer, a portable computing device, a thin client, a personal digital assistant (PDA), a handheld cellular phone, a mobile phone, a smart phone, a handheld device having wireless connection capability, or any other electronic device suitable for communicating data via the network 130.

The student terminals 120 may be configured to display provided questions/mathematical problems and provide an interactive interface with which to interact. The interactive interface enables students to input statements on a step-by-step basis to find solutions for given questions. The students may make inputs that are then transmitted to the teacher terminal 104 for further processing. The inputs may be of any kind. For example, the students may click dedicated buttons to select a certain mathematical operation (e.g., sum up, subtract, divide, multiply, square root, raise to a degree, etc.); input numbers, characters, words, phrases; and so forth.

With continuing reference to FIG. 1, the teacher terminal 104 may be configured to control the overall teaching process. More specifically, the teacher terminal 104 may be provided with options to provide multiple questions (mathematical problems) to students via the student terminals 120, aggregate statements made by the students, process aggregated statements, and display educational progress (i.e., information on correct and wrong steps taken by students in solving particular mathematical problems).

In the shown example, the teacher terminal 104 comprises a system 140 for teaching mathematics. The system 140 for teaching mathematics can be implemented as hardware, software, or a combination thereof to manage the educational process. According to various embodiments, the system 140 for teaching mathematics may provide various mathematical problems to student terminals 120 and aggregate statements provided by the students on every step of solving the given mathematical problems. The aggregated (and optionally sorted) information is readily provided to the teacher terminal 104 for displaying. The teacher may manage the education process by interacting with the system 140 for teaching mathematics. Those skilled in the art will understand that managing the educational process by teachers may be differently and variously implemented.

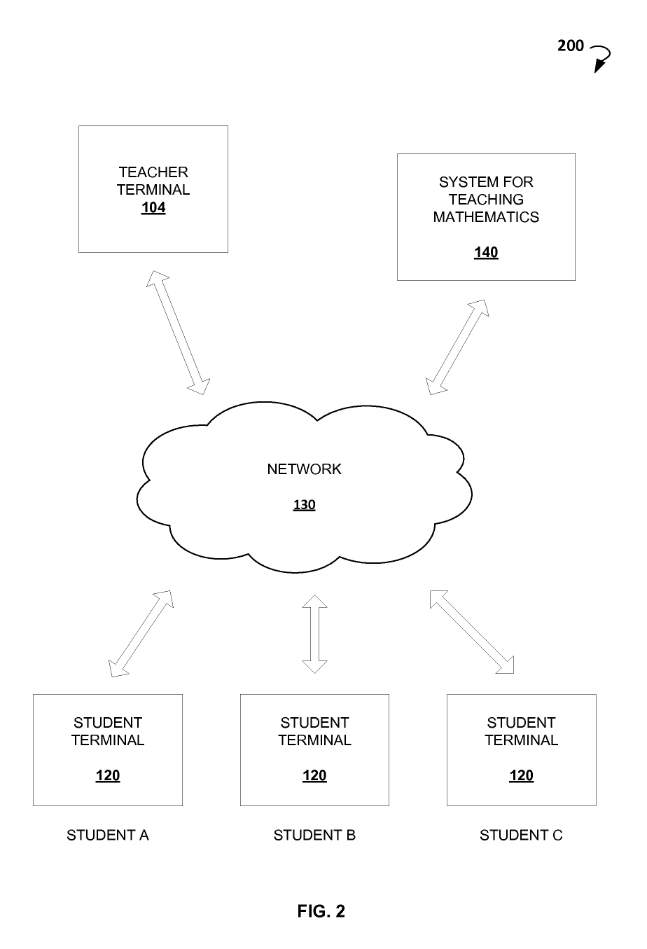

FIG. 2 shows a block diagram illustrating a networked system environment 200 suitable for implementing methods of teaching students to solve mathematical problems according to another example embodiment.

The system environment 200, in general, is similar to one the discussed above with reference to FIG. 1; however, the system 140 for teaching mathematics is implemented as a stand-alone system, and it is not integrated with the teacher terminal 104. Instead, the system 140 for teaching mathematics can be implemented as a server (e.g., a web-based server). However, the functionality of the system 140 for teaching mathematics is the same (i.e., it enables, among other things, to provide students with various mathematical problems, aggregate statements provided by the students, and process the statements so that the summary information on how students approaching in finding solutions are provided to the teacher terminal 104 for further displaying).

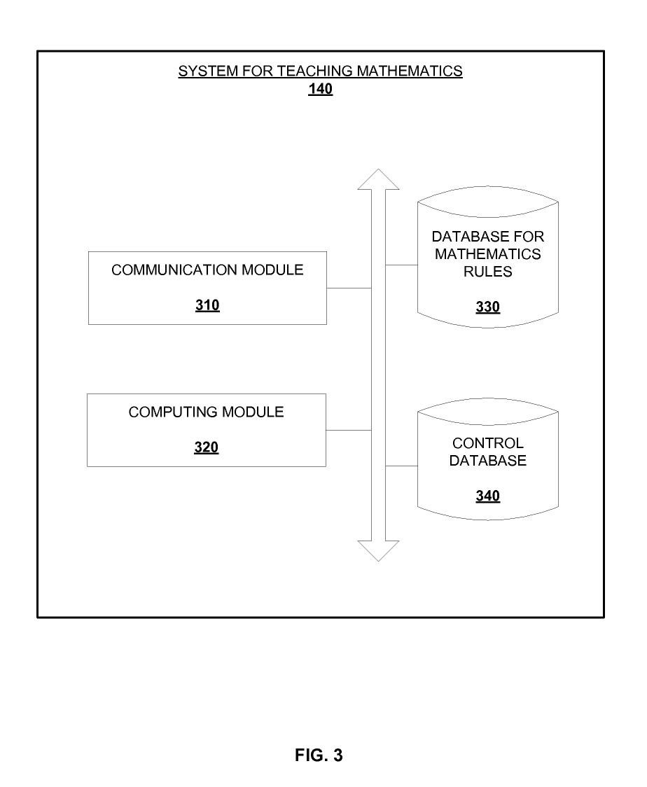

FIG. 3 is a block diagram of the system 140 for teaching mathematics, according to an example embodiment. In this embodiment, the system 140 for teaching mathematics may include a communication module 310, a computing module 320, a database for mathematical rules 330, and a control database 340. In other embodiments, the system 140 for teaching mathematics may include additional, fewer, or different modules for various applications. Furthermore, all modules can be integrated within a single apparatus, or, alternatively, can be remotely located and optionally be accessed via a third party.

The communication module 310, in general, can be configured to transmit data between the system 140 for teaching mathematics, the teacher terminal 104, and the student terminals 120. More specifically, the communication module 310 can be configured to provide question descriptions to one or more student terminals 120. The question descriptions may represent mathematical problems and any other supportive information. The question descriptions can be presented as text, images, video, or audio. The communication module 310 can be further configured to aggregate subsequent statements from the one or more student terminals 120, which are given during the process of solving the provided mathematical problems. Accordingly, subsequent statements may represent “steps” in the solution of the mathematical problem as input by the students via the student terminals 120.

The communication module 310 is further configured to provide aggregated information as stored in the control database 340 to the teacher terminal 104 for further displaying. The aggregated information relates to the educational process and, more specifically, to one or more of the following: correct steps made by a particular student with respect to a certain mathematical problem given, incorrect steps made by a particular student with respect to a certain mathematical problem given, provided answers to questions, student information (e.g., name), scores, marks, and so forth.

According to some embodiments, the communication module 310 is further configured to receive hint requests generated by students and associated with a particular step in the solution of a certain mathematical problem. Such requests are then transmitted to the computing module 320 for further processing.

The computing unit 320 performs computational operations and data processing necessary for implementation methods described herein. More specifically, the computing unit 320 can be configured to match the statements provided by the students against the database 330 of mathematical rules. The computing unit 320 can be further configured to store information on steps taken by students and also student information, and the result of the match (i.e., correct or incorrect step).

The computing unit 320 can be further configured to send an error signal to a particular student terminal 120 if a statement provided by a particular student does not match a corresponding mathematical rule associated with the mathematical problem. Alternatively, the computing unit 320 can send a confirmation signal to the particular student terminal 120 if a statement provided by a particular student matches a corresponding mathematical rule associated with the mathematical problem.

The computing unit 320 can be further configured to receive (via the communication module 310) hint requests associated with a particular step in the solution of the mathematical problem and generated by a particular student, store information on the steps and the particular students who sent the hint requests in the control database 340, and also provide supportive information to the particular student terminals in response to the hint requests.

The computing module is further configured to enable or disable highlighting of one or more parts related to the mathematical problem on at least one student terminal 120 in response to a control command given via the teacher terminal 104.

The database 330 of mathematical rules can be configured to store mathematical rules associated with various mathematical problems. It may also store answers to various questions, and, in general, information stored in the database 330 of mathematical rules is used to determine if a particular answer or step taken by a student is correct or not.

The control database 340 can be configured to store any information related to the educational process (i.e., student information, steps taken by the students, information on which steps were done correctly, information on which steps were done incorrectly, information as to which student generated a hint request and at what step, and so forth).

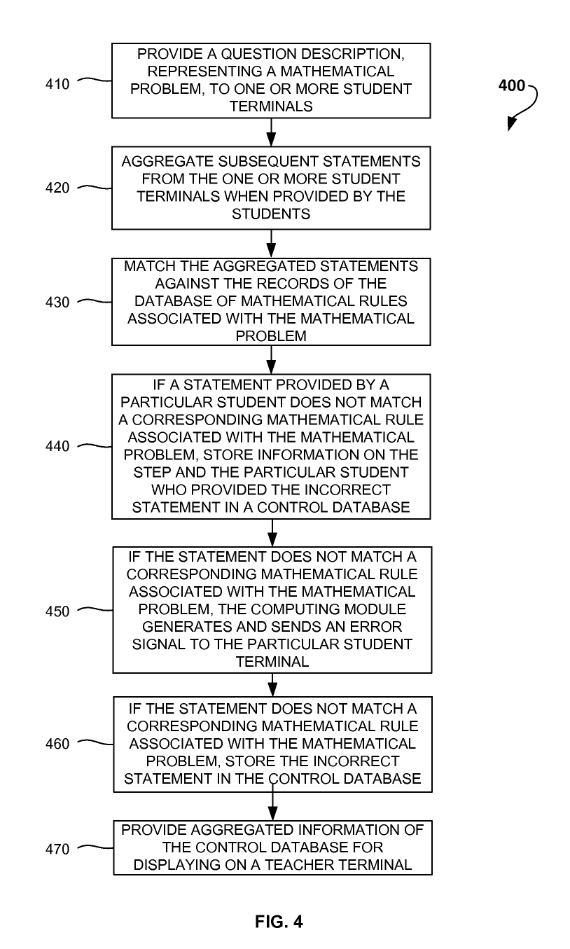

FIG. 4 is a process flow diagram showing a method 400 for teaching mathematics, according to an example embodiment. The method 400 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the system 140 for teaching mathematics, and the various modules of the system 140 for teaching mathematics can perform the method 400. Each of these modules can comprise processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

As shown in FIG. 4, the method 400 may commence at operation 410 with the communication module 310 providing a question description, representing a mathematical problem, to one or more student terminals 120.

At operation 420, the communication module 310 may aggregate subsequent statements from the one or more student terminals 120 when provided by the students. The subsequent statements may represent steps in the solution of the mathematical problem given to the students.

At operation 430, the computing module 320 matches the aggregated statements against the records of the database of mathematical rules 330 associated with the mathematical problem.

At operation 440, it is determined whether the statement provided by a particular student matches a corresponding mathematical rule associated with the mathematical problem as stored in the database of mathematical rules 330, and if does not, the computing module 320 stores information on the step and the particular student who provided the incorrect statement in the control database 340.

At operation 450, if the statement does not match a corresponding mathematical rule associated with the mathematical problem, the computing module 320 generates and sends an error signal to the particular student terminal 120. Alternatively, a confirmation signal can be sent.

At operation 460, if the statement does not match a corresponding mathematical rule associated with the mathematical problem, the computing module 320 may store the incorrect statement in the control database 340.

In some embodiments (not shown), if the statement matches a corresponding mathematical rule associated with the mathematical problem, the computing module 320 stores information on the step and the particular student provided the correct statement in the control database 340.

At operation 470, the computing module 320 provides aggregated information of the control database 340 for displaying on teacher terminal 104. In other words, the computing module 320 provides aggregated information on whether involved students made any mistakes on certain steps of solving particular mathematical problems, according to one example. In some instances, there can be also information provided on what mistakes were made, whether or not the students generated a hint request, and so forth.

In some example embodiments (not shown), the computing module 320 may sort the aggregated information stored in the control database 340 before displaying it on the teacher terminal 104. The sorting process may be performed against student names, correct statements, incorrect statements, and so forth. Additionally, the statistical information can also be generated and presented to the teacher.

Furthermore, in some embodiments (not shown), the computing module 320 may enable or disable highlighting of one or more parts related to the mathematical problem on at least one student terminal 120 in response to a corresponding control command given via the teacher terminal 104.

In addition, in some embodiments (not shown), the computing module 320 may receive hint requests associated with a particular step in the solution of the mathematical problem. If this is the case, the computing module 320 stores, in the control database 340, information on the step and the particular student who sent the hint request, and provides supportive information to the particular student terminal 120 in response to the hint request.

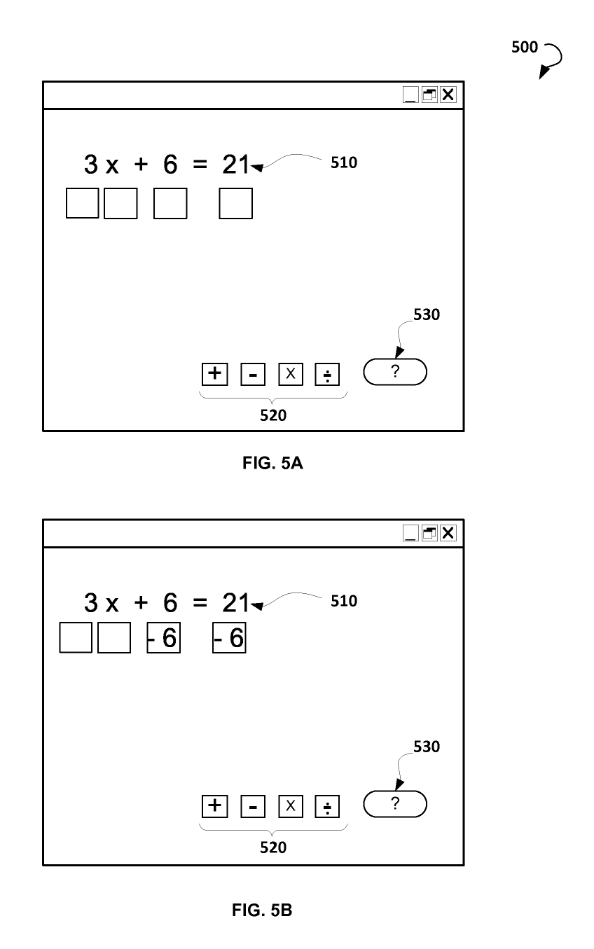

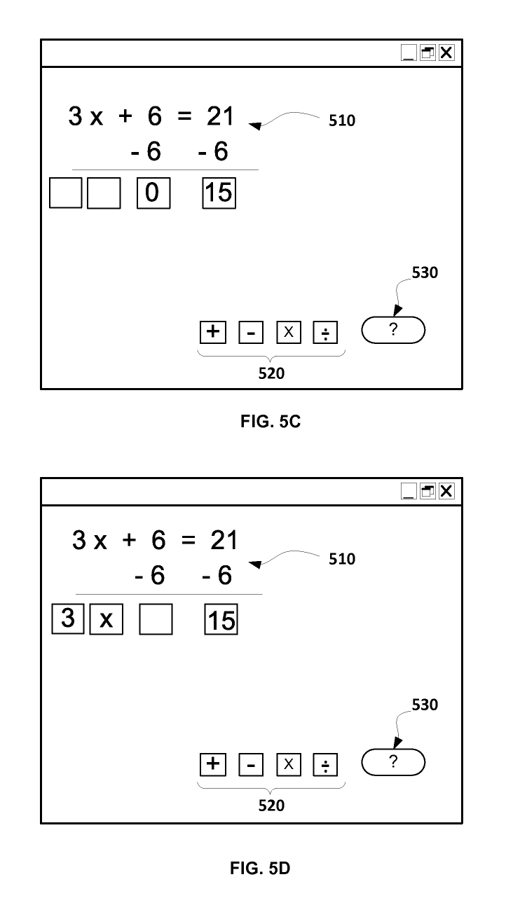

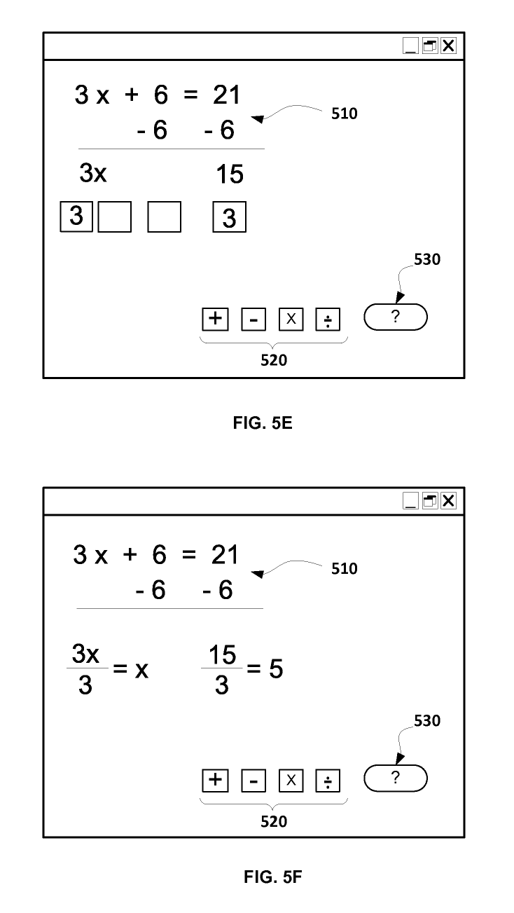

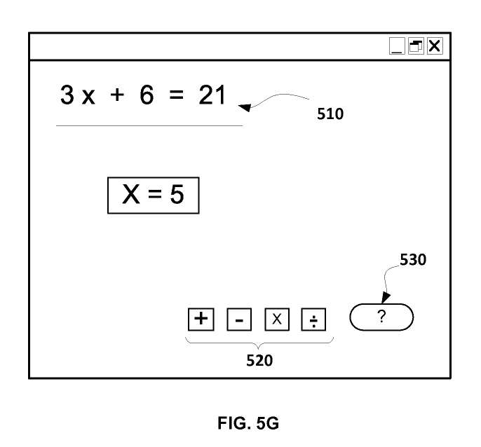

FIGS. 5A-5G are simplified illustrations of a graphical user interface 500 displayable on the student terminal 120, according to an example embodiment. The graphical user interface 500 may be represented as a window (e.g., a browser window) to show its content. In one example, the graphical user interface 500 may be shown on a display of the student terminal 120 via a browser.

More particularly, FIGS. 5A-5G represent an example of how students may be provided with a mathematical problem and how they can solve it on a step-by-step basis. As shown in FIG. 5A, the graphical user interface 500 may comprise a section 510 to present a question or a mathematical problem that shall be solved by a student. In this example, the student should solve the equation “3x+6=21.” Some parts of this equation may be highlighted in order to help the student in solving this problem.

With continuing reference to FIG. 5A, the graphical user interface 500 may comprise control buttons 520 to enable the student to select a mathematical operation (e.g., sum up, subtract, multiply, or divide). There can be also a hint button 530 (shown with a question mark) to generate a hint request.

In this example, the student presses the control button 520 to make a subtract procedure, and then the student inputs a value to subtract in input boxes. As shown in FIG. 5B, it is now displayed that both parts of the equation will be subjected to subtraction by the value of “6.” The next screen, as shown in FIG. 5C, will display the result of the subtraction. FIG. 5D represents the equation after the performed step. The next step of the student is to divide both parts of the equation by the value of “3.” For this purpose, the student clicks the control button 520 to make a dividing procedure, and then inputs a value to be used for dividing both parts of the equation in input boxes. In FIG. 5E, there is shown that both parts of the equation are about to be divided by the value of “3.” Further, as shown in FIG. 5F, the result of applying dividing procedure is shown. At final FIG. 5G, the student obtains a final answer of “x=5.”

It should be noted that at any step the student may press the hint button 530 to generate a hint request. In response, some parts of equation may be highlighted, thereby giving a tip to the student to perform a certain action. However, in some other embodiments, in response, some text, images, equations, video, or audio can be presented.

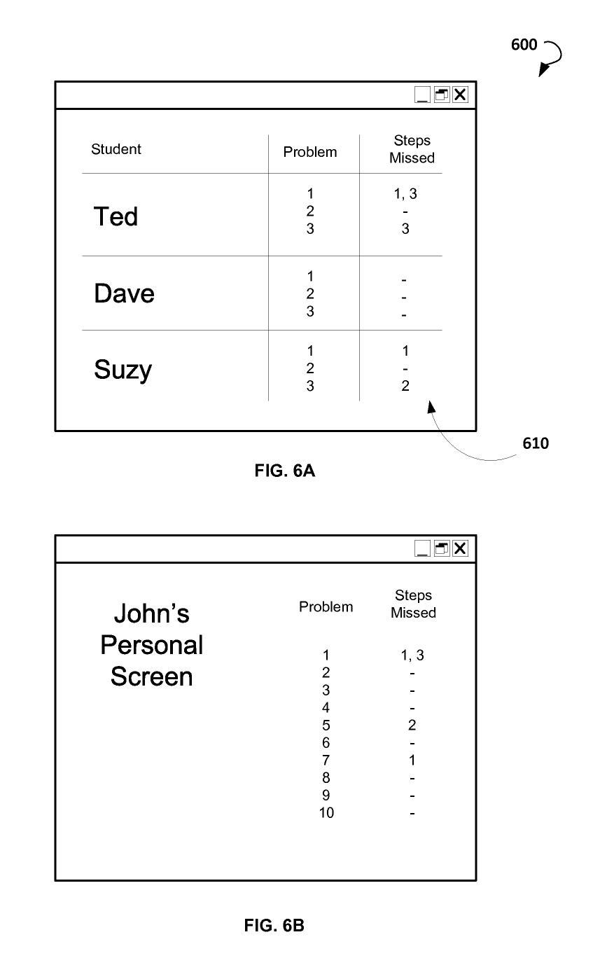

FIGS. 6A and 6B are simplified illustrations of a graphical user interface 600 displayable on a teacher terminal 104, according to an example embodiment. The graphical user interface 600 may be represented as a window (e.g., a browser window) to show its content. In one example, the graphical user interface 600 may be shown on a display of the teacher terminal 104 via a browser.

As shown in FIG. 6A, there is an example graphical user interface 600 showing a group of students and their results in attempting to solve three mathematical problems. In the section 610, there is provided a summary on sections that were missed or the student made a mistake on. In other words, the graphical user interface 600 on FIG. 6A shows aggregated information on the education process, and this information can be populated or updated in real time. Thus, the teacher may review the progress of all students at a glance.

However, the teacher may select a particular student in order to review all of his scores and the way he approached finding solutions for multiple mathematical problems. In FIG. 6B, there is shown a “personal page” and also information on every unsuccessful (and optionally successful) step taken.

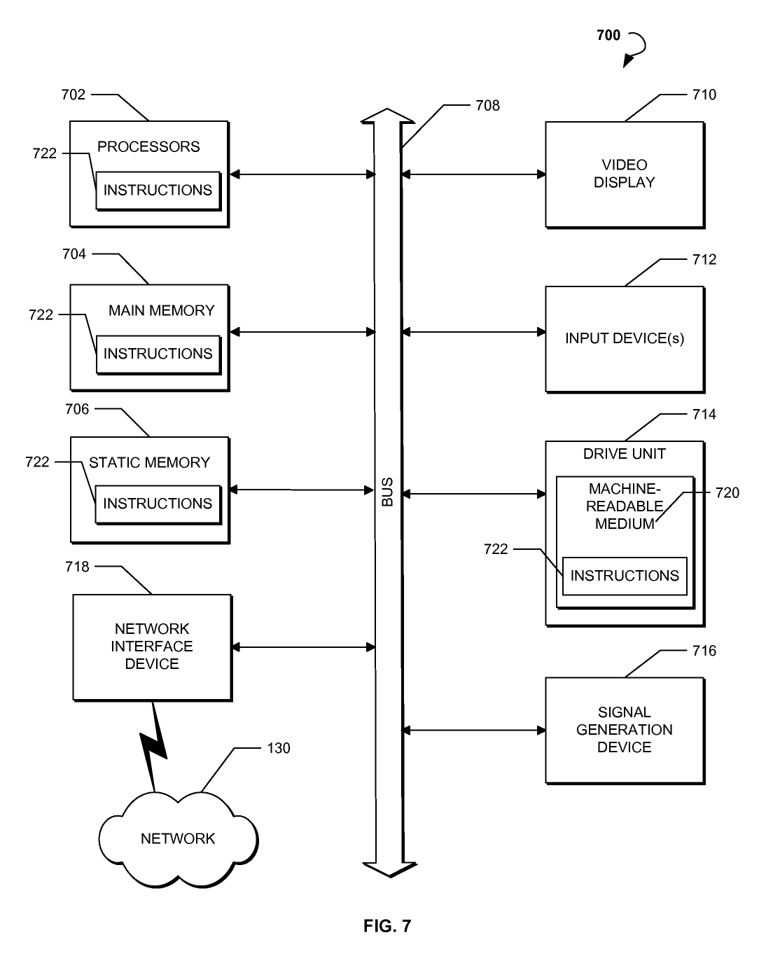

FIG. 7 shows a diagrammatic representation of a computing device for a machine in the example electronic form of a computer system 700, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU), a graphics processing unit (GPU), or both), and a main memory 704 and a static memory 706, which communicate with each other via a bus 708. The computer system 700 can further include a video display unit 710 (e.g., a liquid crystal display (LCD) or a cathode ray tube (CRT)). The computer system 700 also includes at least one input device 712, such as an alphanumeric input device (e.g., a keyboard), a cursor control device (e.g., a mouse), a microphone, a digital camera, a video camera, and so forth. The computer system 700 also includes a disk drive unit 714, a signal generation device 716 (e.g., a speaker), and a network interface device 718.

The disk drive unit 714 includes a computer-readable medium 720, which stores one or more sets of instructions and data structures (e.g., instructions 722) embodying or utilized by any one or more of the methodologies or functions described herein. The instructions 722 can also reside, completely or at least partially, within the main memory 704 and/or within the processor 702 during execution thereof by the computer system 700. The main memory 704 and the processor 702 also constitute machine-readable media.

The instructions 722 can further be transmitted or received over the network 130 via the network interface device 718 utilizing any one of a number of well-known transfer protocols (e.g., Hyper Text Transfer Protocol (HTTP), CAN, Serial, and Modbus).

While the computer-readable medium 720 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks (DVDs), random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, computer-implemented methods and systems for teaching students how to solve mathematical problems are described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for teaching mathematics, the method comprising:
providing a question description to one or more student terminals, the question description representing a mathematical problem;
aggregating subsequent statements from the one or more student terminals, wherein the subsequent statements represent steps in a solution of the mathematical problem;
matching the statements against a database of mathematical rules associated with the mathematical problem;
storing information on the step and the particular student who provided the incorrect statement in a control database if a statement provided by a particular student does not match a corresponding mathematical rule associated with the mathematical problem; and
providing aggregated information of the control database for displaying on a teacher terminal.

2. The computer-implemented method of claim 1, further comprising:
sending an error signal to the particular student terminal if a statement provided by a particular student does not match a corresponding mathematical rule associated with the mathematical problem; and
sending a confirmation signal to the particular student terminal if a statement provided by a particular student matches a corresponding mathematical rule associated with the mathematical problem.

3. The computer-implemented method of claim 1, wherein a statement comprises one or more of a mathematical operator, a number, and a character.

4. The computer-implemented method of claim 1, further comprising:
receiving a hint request associated with a particular step in the solution of the mathematical problem; and
storing information on the step and the particular student who sent the hint request in the control database.

5. The computer-implemented method of claim 4, further comprising:
providing supportive information to the particular student terminal in response to the hint request.

6. The computer-implemented method of claim 1, wherein supportive information comprising one or more of an answer to the mathematical problem and a suggestion on an action to be performed by the particular student.

7. The computer-implemented method of claim 1, further comprising:
storing the incorrect statement in the control database if a statement provided by a particular student does not match a corresponding mathematical rule associated with the mathematical problem.

8. The computer-implemented method of claim 1, further comprising:
enabling or disabling highlighting of one or more parts related to the mathematical problem on at least one student terminal in response to a control command given via the teacher terminal.

9. The computer-implemented method of claim 1, wherein the mathematical problem comprises a multiple-step mathematical problem.

10. The computer-implemented method of claim 1, further comprising:
storing information on the step and the particular student who provided the correct statement in the control database if a statement provided by a particular student matches a corresponding mathematical rule associated with the mathematical problem.

11. The computer-implemented method of claim 1, further comprising:
sorting the aggregated information in the control database before displaying on the teacher terminal, wherein the sorting is performed against student names, correct statements, and incorrect statements.

12. A system for teaching mathematics, the system comprising:
a communication module configured to provide a question description to one or more student terminals, the question description representing a mathematical problem, aggregate subsequent statements from the one or more student terminals, wherein the subsequent statements represent steps in a solution of the mathematical problem; and
a computing module configured to match the statements against a database of mathematical rules associated with the mathematical problem, and if a statement provided by a particular student does not match a corresponding mathematical rule associated with the mathematical problem, store information on the step and the particular student who provided the incorrect statement in a control database; and
wherein the communication module is further configured to provide aggregated information of the control database for displaying on a teacher terminal.

13. The system of claim 12, wherein the computing module is further configured to:
send an error signal to the particular student terminal if a statement provided by a particular student does not match a corresponding mathematical rule associated with the mathematical problem; and
send a confirmation signal to the particular student terminal if a statement provided by a particular student matches a corresponding mathematical rule associated with the mathematical problem.

14. The system of claim 12, wherein
the communication module is further configured to receive a hint request associated with a particular step in the solution of the mathematical problem; and
the computing module is further configured to store information on the step and the particular student who sent the hint request in the control database.

15. The system of claim 14, wherein the computing module is further configured to provide supportive information to the particular student terminal in response to the hint request.

16. The system of claim 12, wherein the computing module is further configured to:
store the incorrect statement in the control database if a statement provided by a particular student does not match a corresponding mathematical rule associated with the mathematical problem.

17. The system of claim 12, wherein the computing module is further configured to:
enable or disable highlighting of one or more parts related to the mathematical problem on at least one student terminal in response to a control command given via the teacher terminal.

18. The system of claim 12, wherein the computing module is further configured to:
store information on the step and the particular student provided the correct statement in the control database if a statement provided by a particular student matches a corresponding mathematical rule associated with the mathematical problem.

19. A networked system teaching mathematics, the system comprising:
a communication network;
at least one teacher terminal; and
one or more student terminals;
wherein each student terminal is operably connected to the at least one teacher terminal via the communication network; and
wherein the at least one teacher terminal comprises a computer-readable medium having instructions stored thereon, which when executed by the at least one teacher terminal cause the at least one teacher terminal to:
provide a question description to one or more student terminals, the question description representing a mathematical problem;
aggregate subsequent statements from the one or more student terminals, wherein the subsequent statements represent steps in a solution of the mathematical problem;
match the statements against a database of mathematical rules associated with the mathematical problem;
if a statement provided by a particular student does not match a corresponding mathematical rule associated with the mathematical problem, store information on the step and the particular student who provided the incorrect statement in a control database; and
provide aggregated information of the control database for displaying on a teacher terminal.
